(19) United States
(12) Patent Application Publication
(10) Pub. No.: US 2025/0083549 A1
(43) Pub. Date: Mar. 13, 2025

(54) DEVICES, SYSTEMS, AND METHODS FOR OPTIMIZATION OF DISPATCH SCHEDULES FOR DISCHARGING AND CHARGING OF ELECTRIC VEHICLES FOR USE IN VEHICLE-TO-GRID ACTIVITIES

(71) Applicant: FERMATA ENERGY LLC, Charlottesville, VA (US)

(72) Inventors: Arnab BHATTACHARYA, Tacoma, WA (US); Christian BROWN, San Francisco, CA (US); Jack PFEIFFER, San Francisco, CA (US); Oliver GARNETT, San Francisco, CA (US)

(73) Assignee: FERMATA ENERGY LLC, Charlottesville, VA (US)

(21) Appl. No.: 18/244,067

(22) Filed: Sep. 8, 2023

(51) Int. Cl. B60L 53/62; B60L 55/00; H02J 7/00

(52) U.S. Cl. CPC B60L 53/62; B60L 55/00; H02J 7/0068

(57) ABSTRACT

The present invention is directed to electronic devices, systems, and methods for optimizing dispatch schedules for an electric vehicle battery in communication with the electronic device to maximize the revenue generation from vehicle-to-grid activities at a site while also preserving battery health. The devices, systems, and methods may determine, using an optimization algorithm, the dispatch schedule for the electric vehicle battery and control a charge or discharge of the electric vehicle battery based on the dispatch schedule. The optimization algorithm may determine the dispatch schedule based on forecasts for future anticipated energy needs of the site and forecasts for future anticipated energy production of the site. The optimization algorithm may include an objective function including one or more variables. The devices, systems, and methods may introduce a heuristic term to the objective function or penalize the first derivative of a variable of the objective function to optimize the dispatch schedule.

### BACKGROUND

The present disclosure generally relates to devices, systems, and methods of optimizing charging and discharging operations of a bi-directional electrical vehicle battery for monetization or other vehicle-to-grid activities through improved modeling and forecasting of variables related to electric vehicle battery use and performance.

As concerns for the environment and depletion of resources increase, the use of plug-in electric vehicles has become more popular. Such vehicles include battery electric vehicles (BEVs), plug-in hybrid electric vehicles (PHEVs), and hydrogen fuel cell electric vehicles (FCEVs). These vehicles typically include one or more electric motors that are powered by one or more batteries. There are different types of electric vehicle batteries, such as lead-acid, nickel metal hydride, sodium, and lithium-ion. Each such battery may be provided in different storage capacities, which are generally measured in kilowatt-hours (“kWh”).

As the use of electric vehicles has become more prevalent and the availability of such vehicles has increased, attempts have been made to utilize them in revenue generating and/or cost saving activities, such as vehicle-to-grid activities. Conventional vehicle-to-grid activities include demand response services, such as discharging electricity from the electric vehicle batteries to the power grid or throttling the batteries' charging rate as charging costs change. Conventional vehicle-to-grid systems generally do not consider factors related to battery health or optimization of the battery while performing such activities or in creating schedules of charge and discharge commands or otherwise dispatching electric vehicles for use. For example, methods of using temperature data to ensure battery health whenever electricity is discharged from the electric vehicle batteries, particularly during revenue generating and/or cost saving activities, are described in U.S. Pat. No. 11,135,936, incorporated by reference herein in its entirety.

Conventional chargers or standard quick chargers for electric vehicles only allow flow in one direction (i.e., power only flows from the charger to the electric vehicle) and are not suitable for vehicle-to-grid activities. Also, the standard quick charger is a slave to the process of charging the electric vehicle. For example, the standard quick charger automatically begins charging operations when plugged into a vehicle, automatically disengages when the vehicle communicates that it is fully charged and does not perform any assessment of the state of the vehicle to determine what operation to perform. A bi-directional power conversion device, in particular a bi-directional charger for use with an electric vehicle, such as the charger disclosed in U.S. patent application Ser. No. 17/102,284, which is incorporated by reference herein in its entirety, provides bi-directional flow of power to charge the electric vehicle and to discharge the electric vehicle into the grid or building and enables the vehicle to engage in such revenue generating and/or cost saving activities. Further, such a bi-directional charger enables assessment of the state of the vehicle to determine what operation to perform and communicates with software to conduct vehicle-to-grid activities. Such a bi-directional charger may be used to optimize revenue generating and/or cost saving activities by providing bi-directional power flow between an electric vehicle and an AC source, such as a utility grid.

However, a need exists to further optimize the bi-directional charging and discharging of electric vehicles in order to perform vehicle-to-grid activities in a way that maximizes both battery health/performance and the results of the activity.

### BRIEF DESCRIPTION OF THE DRAWINGS

FIGS. 1A-C are diagrams of the basic topology of a bi-directional charger and system for vehicle-to-grid operations.

FIG. 2 is a diagram of the basic topology of a system for bi-directional charging and discharging operations according to the present disclosure.

FIG. 3 is a diagram of the basic topology of a system for bi-directional charging and discharging operations according to the present disclosure.

FIG. 4 is a diagram depicting an exemplary efficiency curve for a bi-directional charger according to the present disclosure.

FIG. 5 is a flow chart according to an embodiment of the present disclosure.

FIG. 6 is a flow chart according to an embodiment of the present disclosure.

FIG. 7 is a diagram depicting discharge profiles of a bi-directional charger according to an embodiment of the present disclosure.

FIG. 8 is a flow chart according to an embodiment of the present disclosure.

FIG. 9 is a flow chart according to an embodiment of the present disclosure.

FIG. 10 is a flow chart according to an embodiment of the present disclosure.

FIG. 11 is a flow chart according to an embodiment of the present disclosure.

FIGS. 12A and 12B are diagrams depicting discharge profiles of a bi-directional charger according to an embodiment of the present disclosure.

FIG. 12C is a flow chart according to an embodiment of the present disclosure.

FIG. 13 is a computer system according to an embodiment of the present disclosure.

In the aforementioned figures, like reference numerals refer to like parts, components, structures, and/or processes.

### DETAILED DESCRIPTION OF THE DISCLOSED EMBODIMENTS

As will be understood by those of ordinary skill in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or by combining software and hardware implementations that may all generally be referred to herein as a “circuit,” “module,” “component,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, radio frequency (RF), etc. or any suitable combination thereof.

Computer program code for carrying out operations for aspects of the present disclosure may be written in any combination of one or more programming languages, such as any of the programming languages listed at https://githut.info/ (e.g., JAVASCRIPT, JAVA, PYTHON, CSS, PHP, RUBY, C++, C, SHELL, C#, OBJECTIVE C, etc.) or other programming languages. The program code may be executed by a processor or programmed into a programmable logic device. The program code may be executed as a stand-alone software package. The program code may be executed entirely on an embedded computing device or partly on an embedded computing device (e.g., partly on a server and partly on a personal computer and partly on an embedded device). The program code may be executed on a client, on a server, partly on a client and partly on a server, or entirely on a server or other remote computing device. The program code also may be executed on a plurality of a combination of any of the foregoing, including a cluster of personal computers or servers. The server or remote computing device may be connected to the client (e.g., a user's computer) through any type of network, including a local area network (LAN), a wide area network (WAN), or a cellular network. The connection also may be made to an external computer or server (e.g., through the Internet using an Internet Service Provider) in a cloud computing environment or offered as a service such as a Software as a Service (Saas).

The electric vehicle in which the present disclosure may be implemented may be any vehicle with a battery that may be utilized as an energy storage asset, including an electric truck, electric bus, electric car, electric forklift, electric motorcycle, electric scooter, electric wheelchair, electric bicycle, etc. While such batteries are typically found in these types of exemplary vehicles, they also may be found in other mobile energy storage assets. It may be important to maintain battery health during bidirectional charging activities, including revenue generating and/or cost saving activities, so that the batteries remain in optimal condition to power the electric vehicles when not being used for such bidirectional charging activities, including revenue generating and/or cost saving activities.

The bi-directional charger, such as the bi-directional charger disclosed in U.S. patent application Ser. No. 17/102,284, which is incorporated by reference herein in its entirety, may be used with any vehicle with a battery that may be utilized as an energy storage asset, including an electric truck, electric bus, electric car, electric forklift, electric motorcycle, electric scooter, electric wheelchair, electric bicycle, etc. (provided it is configured for bi-directional charging). While such batteries are typically found in these types of exemplary vehicles, they also may be found in other mobile energy storage assets. Such a bi-directional charger may interface with the electric vehicle and application software to optimize battery health during revenue generating and/or cost saving activities so that the batteries remain in optimal condition to power the electric vehicles when not being used for such during revenue generating and/or cost saving activities. The charger may be located within the vehicle as part of its internal charging system or outside of the vehicle as an offboard option that is compatible with existing electric vehicles. An offboard DC fast charger, such as the embodiment disclosed below, provides additional operational value as it can charge at a faster rate than an onboard charger, which may only be 3.6 or 6.6 kW depending on the particular vehicle.

The bi-directional charger, such as the bi-directional charger disclosed in U.S. patent application Ser. No. 17/102,284, which is incorporated by reference herein in its entirety, can facilitate power flow from an AC source, such as the utility grid to an electric vehicle or from the electric vehicle to the AC connection. Such a bi-directional charger provides a choice of which of those two operations to perform (i.e., grid-to-vehicle or vehicle-to-grid) and interfaces with (or includes) software to determine when and how to perform a particular operation. Unlike a standard quick charger for electric vehicles, a bi-directional charger, such as the bi-directional charger disclosed in U.S. patent application Ser. No. 17/102,284, which is incorporated by reference herein in its entirety, would report that it is connected to the electric vehicle and is an available resource, while software would then determine what operation to perform and whether to initiate the operation. The connection to the electric vehicle may be required to have an electrical connection or power flow and a communications path for a protocol for accessing the electric vehicle (i.e., a vehicle communications standard). Several competing vehicle communications standards exist. A bi-directional charger, such as the bi-directional charger disclosed in U.S. patent application Ser. No. 17/102,284, which is incorporated by reference herein in its entirety, may use any suitable vehicle communications standard, such as CHAdeMO. Such a charger may also send messages to the electric vehicle through the communications path.

Such revenue generating and/or cost saving activities may be further optimized according to the present disclosure.

Aspects of the present disclosure are described herein with reference to flowchart illustrations and/or block diagrams of methods, apparatuses (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. Those computer program instructions may be provided to a processor of a general-purpose computer, special purpose computer, or other programmable data processing apparatus to produce a machine, such that the instructions, which are executed via the processor of the computer or other programmable instruction execution apparatus, create a mechanism for implementing the functions/acts specified in the flowchart and/or block diagram block or blocks.

Those computer program instructions may also be stored in a computer-readable medium that, when executed, can direct a computer, other programmable data processing apparatus, or other devices to function in a particular manner, such that the instructions, when stored in the computer-readable medium, produce an article of manufacture that includes instructions which, when executed, cause a computer to implement the function/act specified in the flowchart and/or block diagram block or blocks. The computer program instructions also may be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For a more complete understanding of the nature and advantages of embodiments of the present disclosure, reference should be made to the ensuing detailed description and accompanying drawings. Other aspects, objects and advantages of the disclosed embodiments will be apparent from the drawings and detailed description that follows. However, the scope of the disclosed embodiments will be fully apparent from the recitations of the claims.

The disclosed embodiments may determine a dispatch schedule for the electric vehicle battery using an optimization algorithm and control a charge or discharge of the electric vehicle battery based on the dispatch schedule.

For example, the disclosed embodiments may determine a future state of charge of the electric vehicle battery coupled to the electronic device using a piecewise linear approximation, determine a discharge efficiency number based on the future state of charge, and determine anticipated energy needs of a building, The disclosed optimization algorithm may use the discharge efficiency number and the anticipated energy needs of the building to determine the dispatch schedule.

### Introduction of V2X Applications

The disclosed embodiments may be implemented in any “X” number of applications, such as vehicle-to-grid applications, vehicle-to-building applications, vehicle-to-home applications, vehicle-to-vehicle applications, etc. (i.e., vehicle-to-X applications, or “V2X”). The differences in each such “X” application are primarily the system with which the electric vehicle is integrated. For example, the disclosed embodiments may be used to integrate electric vehicles with the electric grid (i.e., vehicle-to-grid) or they may be used to integrate electric vehicles with a building's electric load in a behind-the-meter system (i.e., vehicle-to-building). A behind-the-meter system is a system comprised of the electrical system that is metered by a utility, such as the electrical system in a commercial building or a private home. The grid may be a larger system that includes everything between a plug and the utility. It should therefore be understood that vehicle-to-building applications, vehicle-to-home applications, vehicle-to-vehicle applications, etc. may be part of, or even referred to as, vehicle-to-grid applications.

The disclosed V2X system enables the battery or batteries in an electric vehicle or vehicles to provide energy storage services when the battery of the vehicle is not being used, such as when the vehicle is stationary and/or turned off. In the V2X system, stored energy in the electric vehicle batteries may provide valuable services to virtually anyone in need of additional electricity (e.g., grid operators, utilities, building owners, homeowners, etc.). The electricity from the electric vehicle batteries may be used, for example, to reduce electricity costs and strengthen operational resiliency by reducing the load on other sources of electricity (e.g., the grid, solar panels, stationary batteries, etc.). The V2X system may engage an electric vehicle's batteries in multiple activities or market applications of V2X to generate revenue or conserve resources in addition to bidirectional charging.

Engaging in V2X operations requires an electric vehicle that is configured for bi-directional charging (e.g., a NISSAN brand Leaf electric vehicle), a bi-directional power conversion device at the charging site (e.g., the bi-directional charger disclosed in U.S. patent application Ser. No. 17/102,284, incorporated by reference herein in its entirety), and a software system that enables interoperability between the electric vehicle, charger, power grid, and any other energy assets (e.g., solar, wind, stationary battery, etc.) and is capable of managing and optimizing vehicle-to-grid technology. Any vehicle powered by a battery is capable of V2X operations if it is configured for bi-directional power conversion. A key component of the charger is a bi-directional power conversion structure, or power stage, comprising interconnect devices and power conversion equipment that is configured to charge the vehicle batteries from the grid or discharge the vehicle batteries' stored energy back into the grid or building. This type of bidirectional charging may be provided by locating the charger onboard the electric vehicle itself or locating the charger outside the vehicle as an offboard option that is compatible with existing electric vehicles. The software has several functions, including receiving information from vehicles (e.g., state of charge, battery voltage, maximum charge and discharge current levels, vehicle status, etc.), sending vehicles charge/discharge instructions (e.g., power level, start/stop commands, charger status, etc.), and receiving inputs of various data elements (e.g., current building load kW demand, building load kW demand target not to exceed, weather data (e.g., temperature and humidity), grid market factors, etc.).

The optimization methods of the present disclosure may be configured to provide and/or facilitate any one or more energy services. Examples of energy services include, but are not limited to, frequency regulation, demand charge management, spin/non-spin reserves, voltage support, black start, capacity, energy arbitrage, wholesale energy market arbitrage, resource adequacy, distribution deferral, transmission congestion relief, transmission deferral, time-of-use bill management, demand charge reduction, backup power/resilience (particularly for disaster recovery).

### General Topology of Bi-directional Charger

In general, an electric vehicle charger may include power electronics, one or more controllers, and one or more cable/connector plugs. The power electronics are located inside any suitable enclosure, which protects the electronic components from the elements. The power electronics are responsible for supplying power to the electric vehicle and include passive components (inductors, resistors, capacitors, transformers), passively and actively switched semiconductor devices (switches, rectifiers, protective devices), and other electronics. The one or more controllers are configured to monitor and control charging functions and network functions. And the one or more cable/connector plugs are configured to connect a charger to an electric vehicle (via its charging port or other connection point) to be charged, sometimes referred to as a cable gun. The cable/connector plug may include a locking mechanism to prevent the charger from being disconnected from the electric vehicle (as described in U.S. Provisional Patent Application No. 62/814,712, incorporated by reference herein in their entirety).

Charging stations may comprise multiple chargers and may be located in any suitable place, including, but not limited to, public locations, such as a grocery store, where an individual may charge their electric vehicle, or outside a municipal building to service a fleet of electric vehicles owned by a government entity for municipal use.

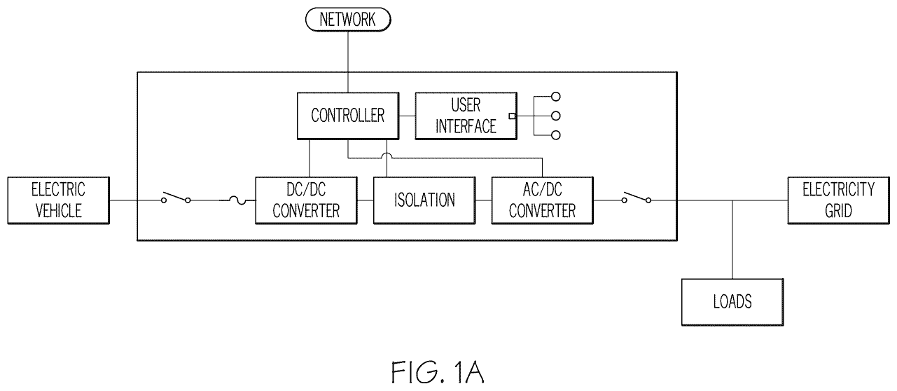

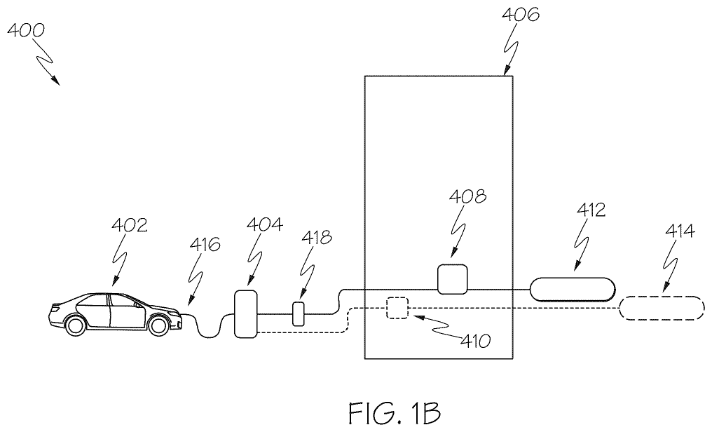

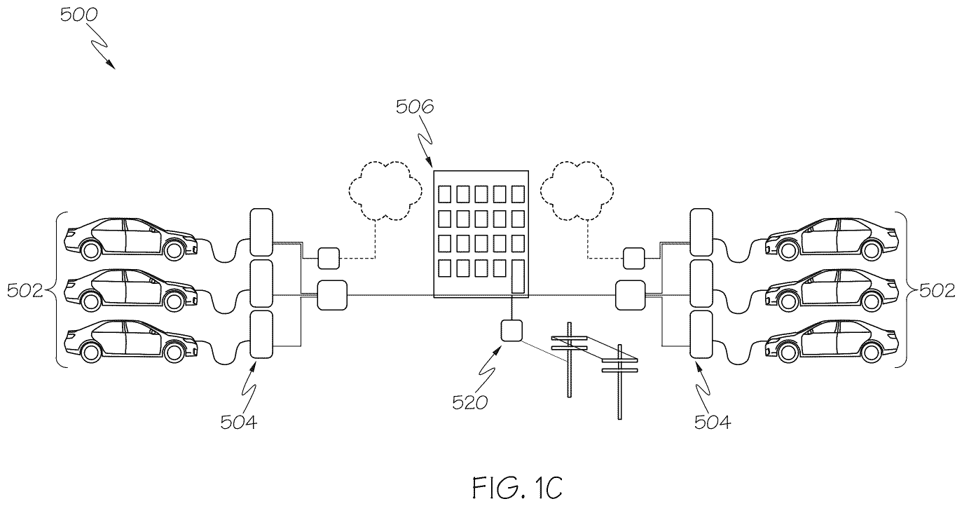

An embodiment of a charger that can be used with the present disclosure is disclosed in U.S. patent application Ser. No. 17/102,284, incorporated by reference herein in its entirety. Such a bi-directional charger includes a controller, DC/DC converter, isolation stage, and AC/DC converter. The controller may provide a user interface via a local display and buttons, or via communication network, including a local network, gateway, or cloud-based system of application. The AC/DC converter may be connected to an electrical grid, utility grid, or other suitable AC electrical connection point (ECP). The DC/DC converter may be connected to an electric vehicle or other suitable DC electrical connection point (ECP). The controller may be in communication with a network, including a local network, gateway, or cloud-based system of application. This basic topology is depicted in FIGS. 1A&B. For example, an electric vehicle 402 may be connected to a bi-directional charger 404 through a quick-change port 416 or other suitable connection mechanism. A disconnect 418 may exist between the charger 404 and building 406. The building 406 has a building electrical panel 408 or other suitable connection mechanism to connect to the grid 412 and a local ethernet port 410 or other suitable connection mechanism to connect to the Internet 414. The controller may also perform commands and tasks as required by specifications for the electric vehicle industry, electric utility industries, or other suitable regulatory or operational control entities. The disclosed bi-directional charger provides high power and efficiency in a smaller package, which allows for wall-mounted options, in turn requiring less labor and equipment to install the chargers.

The local user interface may be any suitable graphical user interface with a display screen and means for user input. For example, the display screen may include a 4×20 character display and 3 buttons for the user to interact with the charger. In addition, the display screen may be angled in such a manner as to keep the screen out of direct sunlight but also be visible from the average person's height. For example, if the display screen is mounted to a wall, the screen may lean forward 5 degrees relative to the wall.

The bi-directional charger disclosed in U.S. patent application Ser. No. 17/102,284, incorporated by reference herein in its entirety, is configured to be used with an electric vehicle implemented in any “X” number of applications, such as vehicle-to-grid applications, vehicle-to-building applications, vehicle-to-home applications, vehicle-to-vehicle applications, etc. (i.e., vehicle-to-X applications, or “V2X”), as described above.

The bi-directional charger disclosed in U.S. patent application Ser. No. 17/102,284, incorporated by reference herein in its entirety, is configured to perform charging and discharging operations between an electric vehicle and an AC electrical connection point, such as the utility grid, a microgrid, an AC branch circuit, or other suitable electric grid. However, the bi-directional charger could also be used to provide power conversion and flow between any suitable DC electrical connection point and AC electrical connection point. This could be done by modifying the input and output mechanisms, such as the cable/connector plug, as required to suit the application.

The rate of charge and discharge of the disclosed bi-directional charger may be controlled or restricted based on communication in terms of maximum current levels (either charging or discharging current polarity) or as maximum power levels (in Watts). These levels may be determined by the technical capability of the bi-directional charger. In another embodiment, the rate of charge and discharge of the disclosed bi-directional charger may also be a function of both the charger itself and the electric vehicle. Electric vehicles as part of their communication protocol may communicate the maximum limits the vehicle can support to the charger. The maximum limits for the electric vehicle may be defined by the vehicle manufacturer and typically constrain vehicle power capability in terms of battery warranty. The charger may then default to a level that is satisfactory to both the charger and the electric vehicle managing the maximum power that is supported on a technology level by the charger and limits in software to maintain the battery warranty terms of the electric vehicle. For example, the bi-directional charger itself could support a maximum of 15 kW, while the electric vehicle may only support a maximum of 10 kW. Thus, the bi-directional charger would default to 10 kW or less to maintain the battery warranty.

The bi-directional charger disclosed in U.S. patent application Ser. No. 17/102,284, incorporated by reference herein in its entirety, may support 220-500 volts (V) DC on the DC side, which may be the interface to the electric vehicle. This range covers specifications for the Nissan LEAF and other electric vehicles on the market. However, any suitable range of voltage levels and other operational specifications may be used depending on the electric vehicle communication standard being used (e.g., CHAdeMO or CCS specifications). On the AC side of the disclosed charger, the grid connection provided may be a standard utility grid connection. This may be a three-phase, 480 V connection as typically seen in industrial equipment in a factory setting. Alternately, the utility grid connection may be a single phase connection appropriate for residential or home usage when used in conjunction with an appropriate AC transformer. Further, the disclosed bi-directional charger may be used indoors and outdoors. The disclosed charger may accommodate a range of environmental conditions and may operate in an ambient temperature range of −20° C. to 40° C.

The bi-directional charger disclosed in U.S. patent application Ser. No. 17/102,284, incorporated by reference herein in its entirety, may use a distributed software environment where command and control of the charger may be performed through any suitable interface, as described in more detail below. This interface may also allow software that is stored in the cloud or on another suitable external server to connect to the charger. The charger may use the interface to obtain information and issue commands. For example, in U.S. patent application Ser. No. 16/802,808, issued as U.S. Pat. No. 11,135,936, which is incorporated by reference herein in its entirety, the disclosed charger may communicate with such software to engage in revenue generating activities. The bi-directional charger disclosed in U.S. patent application Ser. No. 17/102,284, incorporated by reference herein in its entirety, may also have the ability to perform remote firmware updates as needed on the device. This may allow for correction of software problems or the ability to add new features and controls to the charger, such as the ability to perform additional revenue generating activities.

While the disclosure regarding the bi-directional charger in U.S. patent application Ser. No. 17/102,284, incorporated by reference herein in its entirety, primarily relates to the operation of one charger, multiple chargers may be placed and used in parallel. For example, a V2X system 500 for engaging revenue generating and/or cost saving activities is depicted in FIG. 1C that includes a fleet of electric vehicles 502 connected to bi-directional chargers 504 connected to building 506 behind the building's utility meter 520. Each vehicle connects to the building in a similar manner using the components depicted in FIG. 1B. Although the exemplary embodiment of FIG. 1C is depicted with six (6) bi-directional chargers, any suitable number of bi-directional chargers may be used depending on the needs of the particular building and/or availability of and number of electric vehicles able to be scheduled. For example, the software could instruct any suitable number of chargers 504, such as two, simultaneously to be charging or discharging in order to achieve the desired effect for the facility's overall load situation. One of the chargers 504 may send a message to a particular electric vehicle that connects to it where the message may be instructing the user to plug the particular electric vehicle into a different charger (e.g., one of the other five (5) chargers 504), so the present charger may remain open for a vehicle that has a battery that is capable of being discharged into the grid (as described in U.S. patent application Ser. No. 16/802,808, issued as U.S. Pat. No. 11,135,936, incorporated by reference herein in its entirety).

### General Topology of Bi-Directional Charger Network

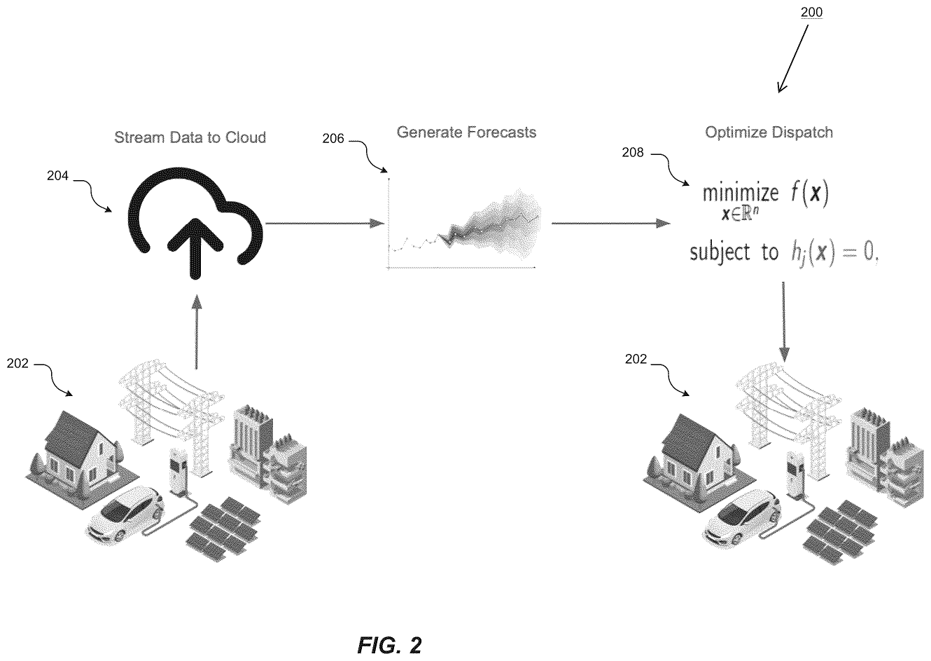

In general, an electric vehicle charging network 200 may include a site 202 where an electric vehicle battery of an electric vehicle may be charged at a bi-directional charger as shown in FIG. 2 (and also as described in U.S. patent application Ser. No. 16/802,808, issued as U.S. Pat. No. 11,135,936, incorporated by reference herein in its entirety). While this disclosure describes a site 202 that comprises one or more components in a particular arrangement, this disclosure contemplates a site 202 that comprises any number of suitable components in any suitable arrangement. As an example, and not by way of limitation, the site 202 may have five separate bi-directional chargers and four electric vehicles coupled to four of the five separate bi-directional chargers. The site 202 may include one or more components to access one or more of a grid, nearby buildings, etc. The site 202 may couple the bi-directional charger to one or more of the grid or nearby buildings.

One or more components of the site 202 (e.g., electric vehicle, bi-directional charger, buildings, grid, etc.) may collect and stream data to a cloud 204. As an example, and not by way of limitation, the electric vehicle may collect data corresponding to a state of charge of the electric vehicle battery and send data to the cloud 204. As another example and not by way of limitation, the bi-directional charger may collect data corresponding to a state of charge of the electric vehicle battery and send data to the cloud 204. The one or more components of the site 202 may collect data to forecast a future energy consumption and future energy production of the site 202. As an example, and not by way of limitation, the one or more components of the site 202 may collect data corresponding to historical building usage of buildings located at the site 202, historical data corresponding to energy production, weather data, energy supplied from other sources, other data that affects the future energy consumption and future energy production of the site. The cloud 204 may represent one or more computing systems of a server associated with the bi-directional charger. The cloud 204 may receive the data associated with the site 202. The cloud 204 may store the received data in one or more databases. The cloud 204 may access the stored received data of one or more databases to perform an analysis on the data.

The cloud 204 may analyze data stored in one or more databases to generate a forecast 206 of future energy consumption and future energy production at a site. As an example, and not by way of limitation, the data collected at the site 202 may comprise information of corresponding to one or more entities consuming energy at the site 202. As another example and not by way of limitation, the data collected at the site 202 may comprise information of one or more entities producing energy at the site 202, such as one or more solar panels, windmills, and the like. For instance, data of historical energy usage for a building and data of historical energy production may be collected by one or more computing systems (e.g., a computer of the building, an energy monitoring system of the building, etc.) and stored to be analyzed to generate a forecast 206 of future energy consumption and future energy production (e.g., from solar panels). The cloud 204 may use a machine-learning model to generate the forecast 206 of the future energy consumption and future energy production at the site 202. The machine-learning model may be trained on historical energy consumption and historical energy production at one or more different sites 202. As an example, and not by way of limitation, the machine-learning model may take inputs corresponding to one or more of weather data (e.g., historical weather data and weather forecasts), historical energy consumption, historical energy production, energy sources, and the like to generate a forecast 206 of the future energy consumption and future energy production at a site 202.

The cloud 204 may use one or more of an optimization algorithm or a machine-learning model to generate a dispatch schedule 208 for one or more electric vehicle batteries of electric vehicles coupled to the bi-directional chargers of the site 202. As an example, and not by way of limitation, the cloud 204 may utilize the forecast 206 of future energy consumption and the optimization algorithm to determine a future time period to charge or discharge one or more electric vehicle batteries to generate dispatch schedule 208, i.e., create a charge and discharge schedule for each electric vehicle and charger. The cloud 204 may send instructions to one or more bi-directional chargers located at the site 202 to implement a dispatch schedule 208 for an electric vehicle battery coupled to the respective bi-directional charger. The dispatch schedule 208 may indicate one or more start and stop times to charge and/or discharge an amount of power over a future period of time using a dispatch profile, including a precise amount that should be charged and/or discharged for each of the one or more start and stop times. Software responsible for initiating the software running the optimization algorithm or model may be triggered by any suitable event or elapsed period of time. For example, the optimization algorithm or model may be triggered anytime an electric vehicle plugs into (or otherwise connects to) a bi-directional charger or unplugs (or otherwise disconnects).

The cloud 204 may periodically generate new forecasts 206, which are used as inputs to the optimization algorithm that solves for dispatch schedule 208 for one or more electric vehicle batteries of electric vehicles coupled to bi-directional chargers located at the site 202. Whenever the optimization algorithm is triggered, the optimization algorithm will retrieve the current forecasts from the cloud or other server. The cloud 204 may receive one or more triggers to generate a new forecast 206 and subsequent new dispatch schedule 208. The one or more triggers may include one or more of a new electric vehicle connecting to a bi-directional charger at the site 202, a change in weather, an emergency signal, changes in energy demand of the grid, and the like. As an example, and not by way of limitation, if a new electric vehicle connects to a bi-directional charger located at a site 202, the bi-directional charger or the electric vehicle may send a signal to the cloud 204 requesting a new dispatch schedule 208. The cloud 204 may regenerate a forecast 206 and subsequent dispatch schedule 208 after receiving the signal. The cloud 204 may store data corresponding to each electric vehicle connecting to the one or more bi-directional chargers at the site 202. The cloud 204 may analyze historical data, such as how long a particular electric vehicle typically stays connected at a site 202 (e.g., the site 202 the electric vehicle is currently located or another site 202 the electric vehicle has previously been located). The cloud 204 may use the historical data to generate a forecast 206 of future energy consumption (e.g., energy consumed to charge the electric vehicle battery of the electric vehicle) and future energy production and a dispatch schedule 208 to send to the bi-directional charger to implement with the electric vehicle battery coupled to the bi-directional charger.

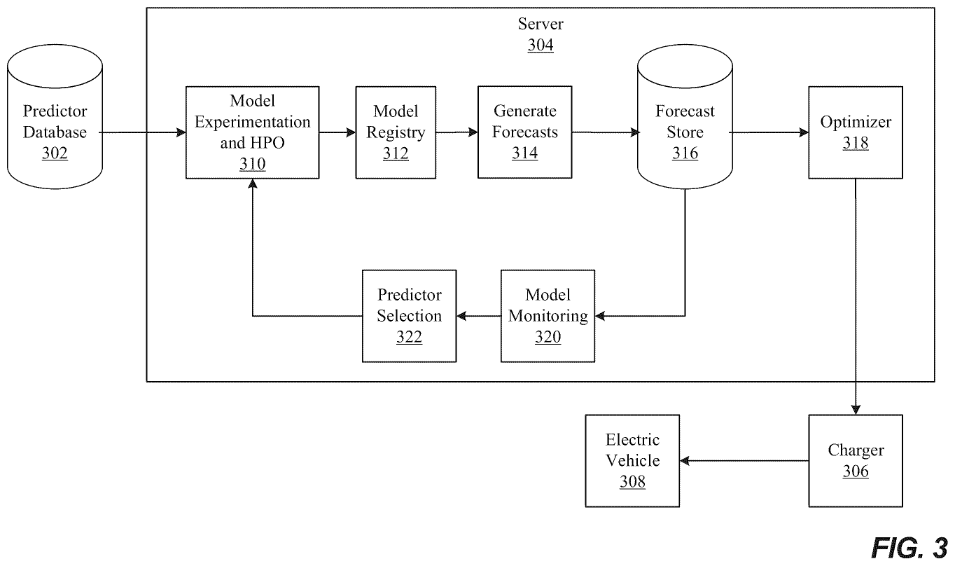

In general, a data science pipeline 300 may include a predictor database 302, a server 304, a bi-directional charger 306, and an electric vehicle 308 as shown in FIG. 3. The data science pipeline 300 may be responsible for creating the dispatch schedules 208. Although this disclosure describes a data science pipeline 300 as containing one or more elements in a particular configuration, this disclosure contemplates a data science pipeline 300 that contains any number of elements in any suitable configuration. As an example, and not by way of limitation, the server 304 may include the predictor database 302. As another example and not by way of limitation, the server 304 may include several electric vehicles 308.

The predictor database 302 may store data to train a machine-learning model and model inference to generate a forecast of future energy consumption and future energy production. The data stored in the predictor database 302 may include latent features that are calculated from raw data. The database to store the raw data may be in another database. The server 304 may access data stored in the predictor database 302 through a model experimentation and hyperparameter optimization (HPO) block 310. The model experimentation and HPO block 310 may generate one or more models to accurately forecast future energy consumption and future energy production at a site. As an example, and not by way of limitation, the server 304 may use the model experimentation and HPO block 310 to generate a first model to accurately forecast future energy consumption and future energy production at a site located in Florida. As another example and not by way of limitation, the server 304 may use the model experimentation and HPO block 310 to generate a second model to accurately forecast future energy consumption and future energy production at a site located in Oregon. There may be a need for two different models because of the different conditions each site experiences, such as weather, different energy demands, and the like. The model experimentation and HPO block 310 may send one or more models (e.g., machine-learning model) to the model registry 312 to register the model to be used for forecasting future energy consumption and future energy production. The server 304 may use one or more models to generate forecasts 314 of future energy consumption and future energy production at one or more sites. The server 304 may store the one or more generated forecasts 314 in a forecast store 316.

The server 304 may access one or more forecasts 314 in the forecast store 316 to generate an optimized dispatch schedule using an optimizer 318 for one or more electric vehicles 308 connected to a charger 306. As an example, and not by way of limitation, the server 304 may access a forecast 314 of future energy consumption and future energy production at a particular site and generate an optimized dispatch schedule to send to a charger 306 to control a charge and/or discharge of an electric vehicle battery of the electric vehicle 308.

The server 304 may access one or more forecasts 314 of future energy consumption and future energy production to monitor one or more models using a model monitoring block 320. The model monitoring block 320 may determine when model drift is detected. When the model monitoring block 320 determines a model drift has occurred, a predictor selection block 322 may determine one or more data points (or variables) to update one or more models through the model experimentation and HPO block 310. The predictor selection block 322 may operate independent of model drift. The model drift may occur when the models used to generate forecasts 314 of future energy consumption has not accounted for all data points that may affect the forecast 314. The predictor selection block 322 may also update the predictor database 302 through one or more new inputs. When model drift is detected, the predictor selection block 322 may determine which variables should be used by the model experimentation and HPO block 310 and then the model experimentation and HPO block 310 may run to select which model is best for the new dynamics at the site.

### Optimization of Electric Vehicle Battery Discharge

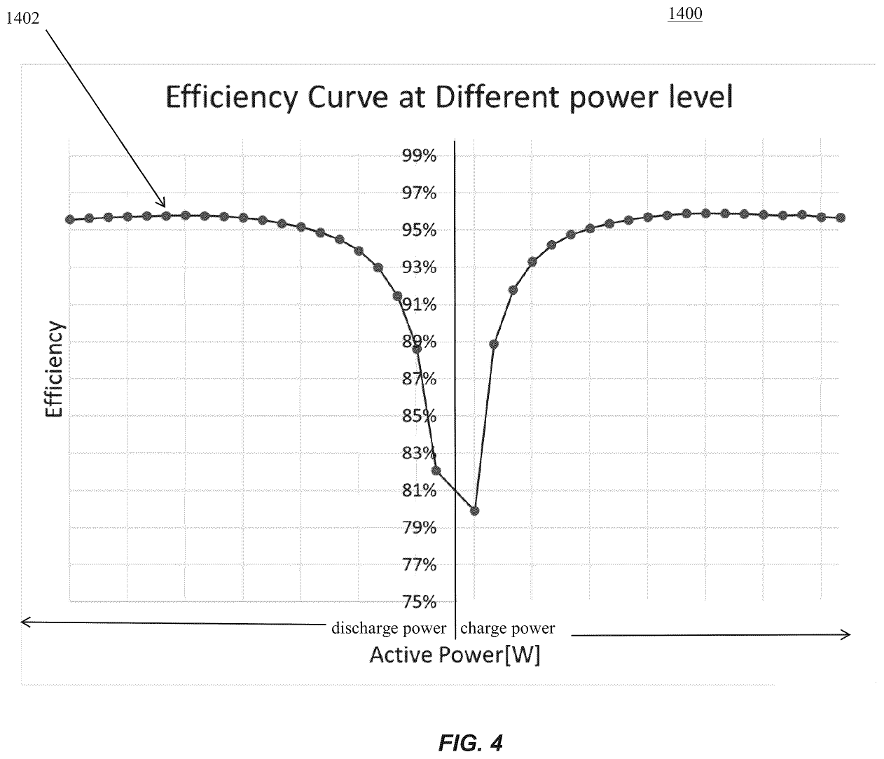

FIG. 4 illustrates a diagram 1400 depicting an efficiency curve for a bi-directional charger. Although this diagram 1400 depicts an exemplary, but not limiting, efficiency curve for a bi-directional charger in a particular manner, the present disclosure contemplates that there could be different efficiency curves for different bi-directional chargers. As an example, and not by way of limitation, the efficiency curve may have a different number of inflection points 1402 and a different shape than as shown in diagram 1400. Models of how power commands (e.g., charge or discharge commands) affect energy stored in a battery (e.g., electric vehicle battery) are needed to determine how much to charge and discharge electric vehicles. An optimization algorithm may be used to determine when it is most economical to charge or discharge the battery. As an example, and not by way of limitation, the optimization algorithm may determine when a user of an electric vehicle may generate the most revenue from discharging the electric vehicle battery of the electric vehicle. The amount of energy received from a charger does not equal the amount of energy lost from the battery due to efficiency losses. To address this, OEMs may provide an efficiency number that indicates how much energy will successfully be extracted from an electric vehicle battery while discharging. This number may be inaccurate because efficiency losses are not constant and will vary depending on one or more parameters including the amount of power that is being discharged, the state of charge of the battery, and internal temperature of the battery. To model this behavior more accurately, a piecewise linear approximation may be used instead of using a constant discharge efficiency number. A more accurate estimate of a future state of charge of electric vehicle batteries may be determined by using a piecewise linear approximation to enable different efficiency numbers for various power ranges. The diagram 1400 may indicate that the inclusion of more inflection points 1402 may provide diminishing returns. There may be a threshold number of inflection points 1402 that provides the optimal estimate of the future state of charge of electric vehicle batteries.

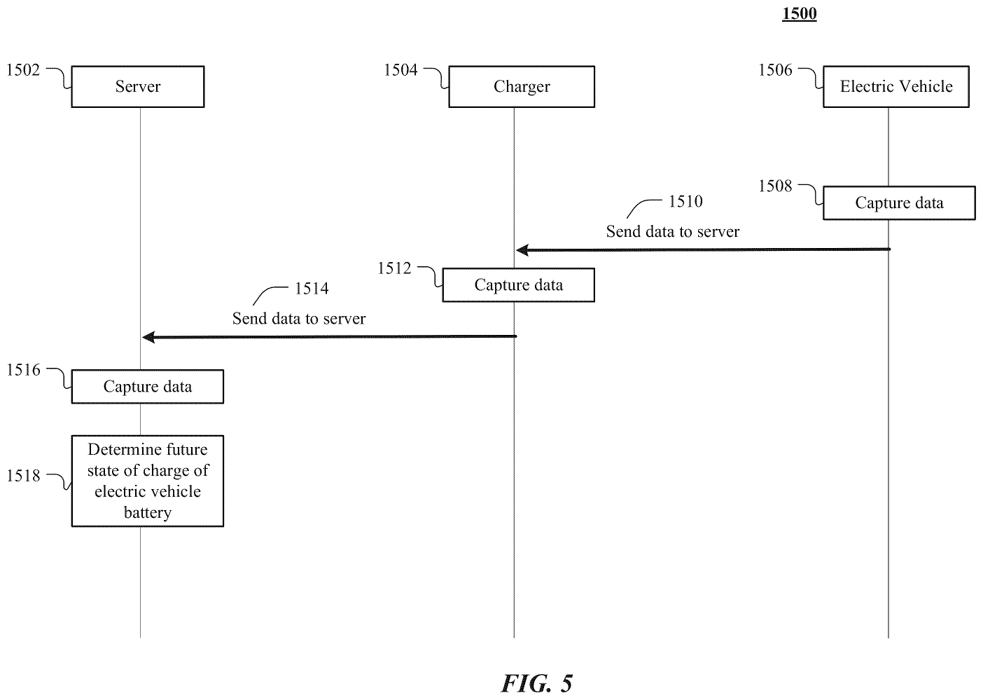

FIG. 5 illustrates a flow chart of a process 1500. The process 1500 may include a server 1502, a bi-directional charger 1504, and an electric vehicle 1506. Although this disclosure describes the process 1500 as including a number of different components in a particular arrangement, this disclosure contemplates the process 1500 as including any number of components in any suitable arrangement. As an example, and not by way of limitation, the process 1500 may include two chargers and two electric vehicles. At step 1508, the electric vehicle 1506 may capture data. The data captured may include one or more of a state of charge of the electric vehicle battery, temperature of the electric vehicle battery, battery voltage, state of health of the battery, charge efficiency of the battery, discharge efficiency of the battery, reactive power of the battery, and the like. At step 1510, the electric vehicle 1506 may send the data captured to the server 1502 through charger 1504. As an example, and not by way of limitation, the electric vehicle 1506 may send data wirelessly to the charger 1504 or through a connection to the charger 1504. In particular embodiments, the electric vehicle 1506 may send the data captured to the server 1502 directly. As an example, and not by way of limitation, the electric vehicle 1506 may send data to the server 1502 wirelessly. At step 1512, the charger 1504 may capture data. The charger 1504 may collect data such as a state of charge of the electric vehicle battery, temperature of the electric vehicle battery, battery voltage, state of health of the battery, location of the charger 1504, the amount of energy needed by the electric vehicle battery, charger temperature, charge efficiency of the battery and charger, discharge efficiency of the battery and charger, current power, reactive power of the battery and charger, and voltage and the like. At step 1514, the charger 1504 may send the data collected from both the electric vehicle 1506 and the charger 1504 to the server 1502. As an example, and not by way of limitation, the charger 1504 may send the data wirelessly to the server 1502. At step 1516, the server 1502 may capture data corresponding to a site where the charger 1504 and the electric vehicle 1506 are located, including the data at steps 1508 and 1512. The data captured by the server 1502 may include the historical weather data, historical energy consumption of one or more buildings coupled to the charger 1504, building power consumption, building frequency, and on-site energy production, and the like. At step 1518, the server 1502 may determine a future state of charge of the electric vehicle battery using an optimization algorithm. The result of solving the optimization algorithm is to generate a dispatch schedule. In solving the optimization algorithm, server 1502 may formulate an objective function and constraints. In formulating the objective function and constraints, server 1502 may use a piecewise linear approximation to determine the future state of charge of an electric vehicle 1506 coupled to the charger 1504; determines a discharge efficiency number based on the future state of charge; and determines the anticipated energy needs of a building coupled to the charger 1504. A plurality of parameters may be used to formulate the objective function and constraints including one or more of the future state of charge of an electric vehicle battery of the electric vehicle 1506 coupled to the charger 1504 an electric vehicle battery of the electric vehicle 1506. The objective function may be solved by the optimization algorithm to generate a dispatch schedule. The charger 1504 may then control a charge or a discharge of the electric vehicle battery of the electric vehicle 1506 pursuant to the dispatch schedule determined as a result of the optimization. Although this disclosure describes one or more steps being performed by a particular component, this disclosure contemplates one or more steps being performed by other components. As an example, and not by way of limitation, the charger 1504 may determine the future state of charge of an electric vehicle 1506 using a piecewise linear approximation. The piecewise linear approximation may determine a discharge efficiency number based on at least one or more parameters comprising an amount of power that is being discharged by the electric vehicle battery, a state of charge of the electric vehicle battery, or an internal temperature of the electric vehicle battery. The piecewise linear approximation may also determine a charge efficiency number. One or more weights may be applied to the one or more parameters to assign different values to each of the one or more parameters. The various weights may be adjusted and changed to accommodate different evaluations of which parameters are more important. As an example, and not by way of limitation, a higher weight may be applied to the internal temperature of the electric vehicle battery when determining a discharge efficiency number. In addition, although this disclosure may describe one or more steps being performed sequentially, the steps may be performed concurrently as part of the optimization.

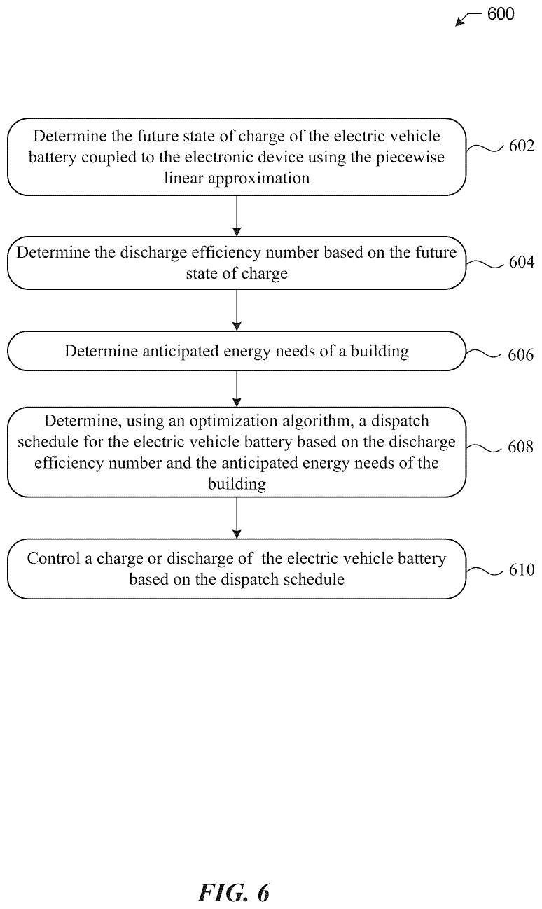

FIG. 6 illustrates a flow diagram of a method 600 for determining a future state of charge of an electric vehicle battery, in accordance with the presently disclosed embodiments. Although FIG. 6 depicts method 600 as occurring in sequential steps, in practice the optimizer solves for all of these variables at once in one problem formulation. The method 600 may be performed utilizing one or more processing devices (e.g., computing device 106) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing data, software (e.g., instructions running/executing on one or more processors), firmware (e.g., microcode), or some combination thereof.

The method 600 may begin at step 602 with the one or more processing devices (e.g., server 1502) determining the future state of charge of the electric vehicle battery coupled to the electronic device using the piecewise linear approximation. The method 600 may then continue at step 604 with the one or more processing devices (e.g., server 1502) determining the discharge efficiency number based on the future state of charge. The method 600 may then continue at step 606 with the one or more processing devices (e.g., server 1502) determining anticipated energy needs of a building. The method 600 may then continue at step 608 with the one or more processing devices (e.g., server 1502) determining, using an optimization algorithm, a dispatch schedule for the electric vehicle battery based on the discharge efficiency number and the anticipated energy needs of the building. The method 600 may then continue at step 610 with the one or more processing devices (e.g., server 1502) controlling a charge or discharge of the electric vehicle battery based on the dispatch schedule. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for determining a future state of charge of an electric vehicle battery including the particular steps of the method of FIG. 6, this disclosure contemplates any suitable method for determining a future state of charge of an electric vehicle battery including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

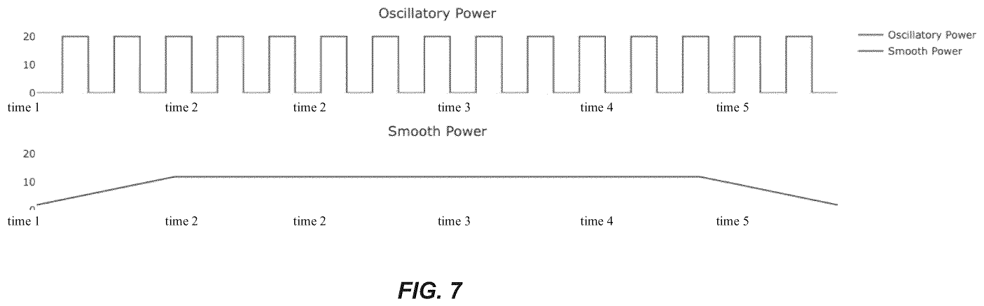

When providing grid services with electric vehicles, there may be several charge and discharge profiles that result in the same economic compensation for an owner. However, certain charge and discharge profiles may have different effects on an electric vehicle battery. For situations where an owner of an electric vehicle is compensated based on a total energy discharged, it may be important to preserve the battery health of the electric vehicle battery. In general, when discharging an electric vehicle battery, chargers may typically use an oscillatory pattern as shown in the diagram 700 in FIG. 7. The smooth pattern 704 shown in diagram 700 may result in a total of the same energy discharged as the oscillatory pattern 702. However, the oscillatory discharge profile may reduce the batteries state of health considerably more than the smooth pattern. In order to change the default behavior of using an oscillatory discharge profile, a penalty term may be added to incentivize smooth transitions between power commands and minimize any sudden changes in the power requested from the charger. The objective function may be defined, for example, as minΣ_{t∈τ}Σ_{v∈V}nₜ^{v}pₜ. Where τ=prediction horizon, t=discrete time index for prediction horizon (t∈τ), Δ=number of decision epochs per hour, cₜ^{v}=charging power at time t per vehicle v, dₜ^{v}=discharging power at time t per vehicle v, pₜ=price of electricity at time t, and nₜ^{v}=energy discharged at time t per vehicle v. To introduce a heuristic term to penalize the power derivative, A may be used. The objective function may be updated in this example to be

$$min {\sum }_{t ∈ τ} {\sum }_{v ∈ V} {n}_{t}^{v} {p}_{t} + Λ \frac{\partial p}{\partial t}$$

with the introduction of Λ. The value of Λ may be set to introduce a penalty term that is not ignored given tolerances for a duality gap. The value of Λ may be set to ten times a configured value of the absolute tolerance of a duality gap.

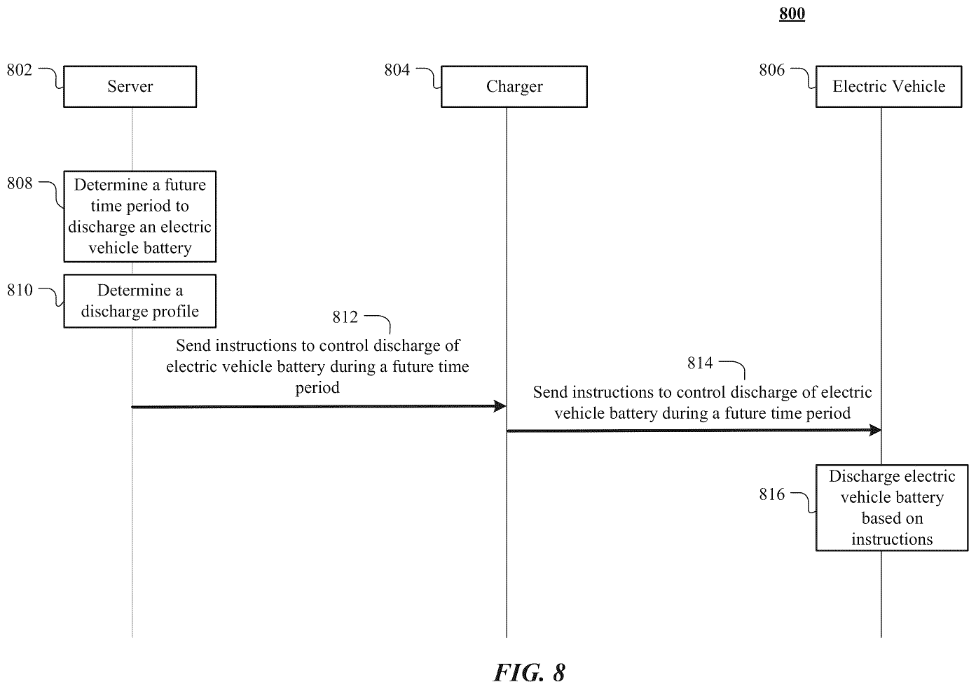

FIG. 8 illustrates a flow chart of a process 800. The process 800 may include a server 802, a bi-directional charger 804, and an electric vehicle 806. Although this disclosure describes the process 2000 as including a number of different components in a particular arrangement, this disclosure contemplates the process 800 as including any number of components in any suitable arrangement. As an example, and not by way of limitation, the process 800 may include two chargers and two electric vehicles. The process 800 may occur after or during the process 1500 of FIG. 5. After collection of data as described in process 1400, at step 808, the server 802 may determine a future time period to discharge an electric vehicle battery of the electric vehicle 806 through the charger 804. The server 802 may determine anticipated energy needs of a building coupled to the charger 804, determine future energy consumption at a site, and the like to determine an amount of energy to discharge from an electric vehicle battery of an electric vehicle 806 through the charger 804. The server 2002 may use an optimization algorithm to determine a future time period to discharge the electric vehicle battery of the electric vehicle 806 coupled to the charger 804. The server 802 may use a discharge efficiency number, anticipated energy needs of the building, and the like to determine the future time period to discharge the electric vehicle battery. The optimization algorithm may determine an optimal time to discharge and charge an electric vehicle 806. As an example, and not by way of limitation, the optimization algorithm may determine that electricity costs during the day at higher and implement a discharge schedule that causes an electric vehicle battery at a particular capacity to discharge during the time where electricity costs are higher. As another example and not by way of limitation, the optimization algorithm may identify a state of charge of an electric vehicle battery and an estimated time the electric vehicle 806 will be coupled to a charger 804 to determine whether the electric vehicle battery has enough energy and time to charge and discharge. The server 802 may also determine an amount of power to discharge during the future time period.

At step 810, the server 802 may determine a discharge profile to discharge the electric vehicle battery of the electric vehicle 2006 during a future time period using the charger 804. The server 802 may use an objective function that implements a heuristic term that penalizes a first derivative of the discharging profile or penalizes a first derivative of power. The heuristic term may be implemented in the objective function to smooth a discharge profile calculated from the objective function to reduce oscillations in the discharge profile. The reduction in oscillations improve the battery health of the electric vehicle battery by reducing rapid changes in a discharge profile. While step 808 and step 810 are depicted sequentially, steps 808 and step 810 may occur simultaneously.

At step 812, the server 802 may send instructions to the charger 804 to control the discharge of the electric vehicle battery during a future time period. The charge 804 may send instructions to the electric vehicle 806 to control the discharge of the electric vehicle battery during a future time period at step 814. The control of the discharge of the electric vehicle battery may indicate when to start and stop a discharge of the electric vehicle battery. The electric vehicle 806 may discharge the electric vehicle battery based on the received instructions at step 816. As an example, and not by way of limitation, the instructions may cause the electric vehicle 806 to discharge a particular amount of power during a future time period using a set discharge profile. The owner of the electric vehicle 806 may provide inputs to adjust the discharge profile used for the discharge of the electric vehicle battery. As an example, and not by way of limitation, if the owner of the electric vehicle 806 provides an input indicating a request to preserve the battery health as much as possible, the server 802 may adjust a heuristic term for the objective function used to determine the discharge profile for the electric vehicle battery of the electric vehicle 806.

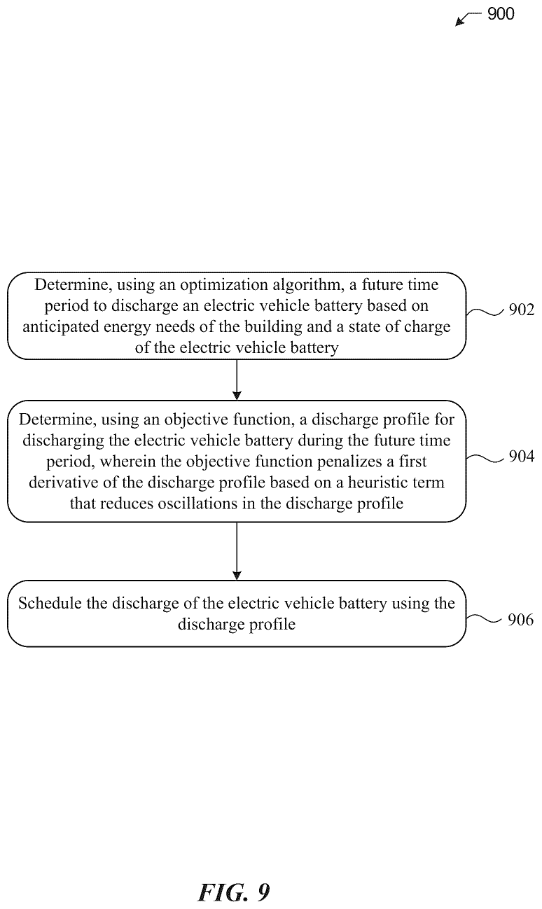

FIG. 9 illustrates a flow diagram of a method 900 for determining a discharge profile, in accordance with the presently disclosed embodiments. The method 900 may be performed utilizing one or more processing devices (e.g., computing device 106) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing data, software (e.g., instructions running/executing on one or more processors), firmware (e.g., microcode), or some combination thereof.

The method 900 includes the one or more processing devices (e.g., server 802) determining, using an optimization algorithm, including an objective function primarily modeling the economic costs and value of charging and discharging the vehicles, a future time period to discharge an electric vehicle battery based on anticipated energy needs of the building and a state of charge of the electric vehicle battery (as depicted step 902) and a discharge profile for discharging the electric vehicle battery during the future time period (as depicted in step 904). The objective function may include a term that penalizes the first derivative of the discharge profile based on a heuristic term that reduces oscillations in the discharge profile. While steps 902 and 904 are depicted as separate steps for illustrative purposes, steps 902 and 904 may be performed concurrently or simultaneously as the optimization algorithm may solve for all variables at the same time. The method 900 may then continue at step 906 with the one or more processing devices (e.g., server 802) scheduling the discharge the electric vehicle battery using the discharge profile. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for determining a discharge profile including the particular steps of the method of FIG. 9, this disclosure contemplates any suitable method for determining a discharge profile including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

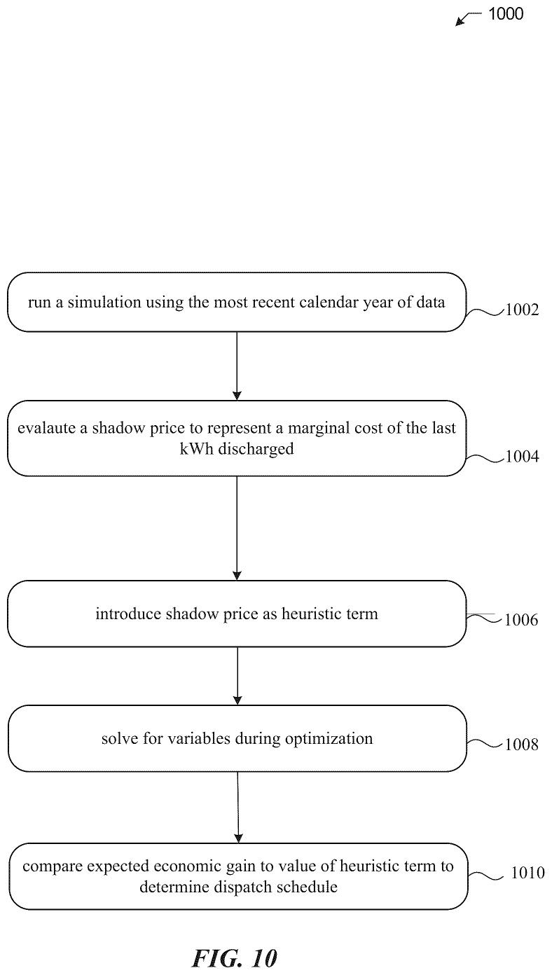

In the exemplary method 1000 of FIG. 10, an optimization algorithm maximizes the amount of money a customer makes by using an electric vehicle for V2X activities, such as wholesale energy market arbitrage, from the finite amount of discharge available by determining how to prioritize when to discharge. Electric vehicles participating in such V2X activities must be mindful of the number of full cycles. A full cycle is when the vehicle discharges an amount equal to the maximum stored energy in the battery minus the minimum stored energy in the battery. The discharge does not need to be continuous in order to be considered a cycle. Limits (i.e., upper bounds), including from OEMs, may be placed on the total amount of energy an electric vehicle may discharge per calendar year. For example, an OEM may stop cycling the battery when the battery approaches the target annual discharges. A customer or user monetizing the electric vehicle by participating in V2X activities, in turn, wants to maximize the amount of money the customer makes from the finite or maximum amount of discharge allowed per calendar year (annual discharge). This may occur at a site (such as 202 in FIG. 2, 400 depicted in FIG. 1B, or 500 depicted in FIG. 1C) participating in V2X activities, such as wholesale energy market arbitrage. Prices for wholesale energy markets fluctuate and as result, the potential earnings that an electric vehicle (such as 402 depicted in FIG. 1B or 502 depicted in FIG. 1C) can receive from cycling the battery also varies from day to day.

According to the exemplary method 1000 of FIG. 10, a simulation may be run for a full calendar year using the customer's data, such as from the most recent calendar year of data, (step 1002) to show the profile of charging power flowing into the battery and discharging power flowing out of the battery over a period of time (such as a calendar year), according to the following variables:

[symbol]

: prediction horizon
t: discrete time Index for prediction horizon (t ∈ [symbol] )
Δ: number of decision epochs per hour [symbol]
: set of EVs [symbol]
: index used for an EV ( [symbol] ∈ [symbol] ) [symbol]
: net energy charged or discharged from vehicle (positive indicating
charge, negative discharge) [symbol]
ᵥ: maximum annual energy discharged per vehicle
cₜ^{v}: charging power flowing into [symbol] -th EV battery at time t
dₜ^{v}: discharging power flowing out of [symbol] -th EV battery at time t
$\begin{matrix}{ℰ}_{t}^{υ} = \frac{{c}_{t}^{υ} - {d}_{t}^{υ}}{Δ} \\ \begin{matrix}min {\sum }_{t ∈ {𝒯}_{i}} {\sum }_{υ ∈ 𝒱} {ℰ}_{t}^{υ} {p}_{t} & \\ s . t . \frac{{\sum }_{t ∈ {𝒯}_{i}} {d}_{t}}{Δ} \leq {𝒟}_{t} & t ∈ 𝒯 , υ ∈ 𝒱\end{matrix}\end{matrix}$

The above variables may assume perfect information and include a constraint that restricts the total amount of energy discharged per vehicle to be less than or equal to a target value.

A shadow price of this constraint term may be evaluated and introduced into the objective function identified above (step 1004). The shadow price may provide an estimate of how important that constraint is to the optimizing model and represents a marginal cost of the last kWh discharged. Accordingly, the above problem may be reformulated as the following 24 hour optimization:

[symbol]

: prediction horizon
t: discrete time index for prediction horizon (t ∈ [symbol] )
Δ: number of decision epochs per hour [symbol]
: set of EVs [symbol]
: index used for an EV ( [symbol] ∈ [symbol] ) [symbol]
: net energy charged or discharged from vehicle (positive indicating
charge, negative discharge) [symbol]
ᵥ: maximum annual energy discharged per vehicle
cₜ^{v}: charging power flowing into [symbol] -th EV battery at time t
dₜ^{v}: discharging power flowing out of [symbol] -th EV battery at time t
η^{v}: heuristic term per vehicle equal to the shadow price
${ℰ}_{t}^{υ} = \frac{{c}_{t}^{υ} - {d}_{t}^{υ}}{Δ} \\ \begin{matrix}min {\sum }_{t ∈ {𝒯}_{i}} {\sum }_{υ ∈ 𝒱} {ℰ}_{t}^{υ} {p}_{t} + {η}^{υ} {d}_{t} & \\ s . t . \frac{{\sum }_{t ∈ {𝒯}_{i}} {d}_{t}}{Δ} \leq {𝒟}_{t} & t ∈ 𝒯 , υ ∈ 𝒱\end{matrix}$

The shadow price may be introduced as a heuristic term (step 1006), as depicted in the above exemplary formulation. The heuristic term may be attached to a discharge power variable that is solved for along with other variables during an optimization window, such as a standard daily optimization window (step 1008). The addition of this heuristic term, according to the above exemplary formulation, results in discharging or cycling the electric vehicle battery only if the expected economic gain (such as from arbitraging the price signal) is greater than this heuristic term, i.e., the marginal cost associated with a particular amount of maximum annual discharge (step 1010). Thus, the heuristic term according to the above exemplary formulation operates as a penalty term and allows a customer to take advantage of energy market events that may pop up unexpectedly. The exemplary formulation described above may also be extended to other V2X activities, such as frequency regulation, frequency response, demand response, demand charge management, PV solar self-consumption, and other suitable V2X activities.

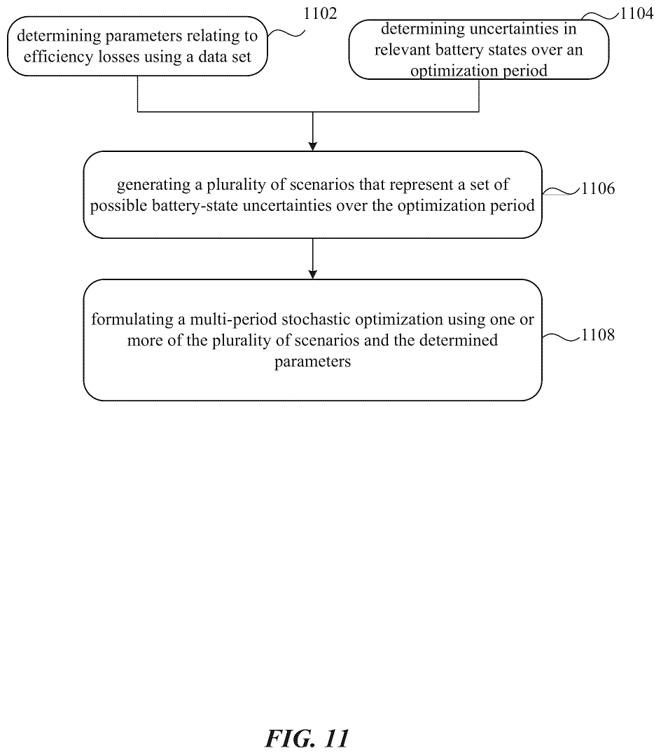

In an exemplary method 1100 of FIG. 11, V2X software according to embodiments of the present disclosure may use an optimization module to execute a complex real-time control strategy to determine optimal charge/discharge decisions for participating electric vehicles (EVs) at DC fast-charging stations (such as depicted in FIGS. 1B and 1C).

At the start of each decision interval, an optimization module utilizes available time-series forecasts (e.g., building power load, EV trip schedules, demand-response duration), along with models for battery efficiency and battery state-of-charge (SoC), to solve a convex optimization problem. Battery efficiency and battery state-of-charge are not constant. For example, efficiency of Li-ion EV batteries is rarely constant and exhibits highly non-linear relationships with ambient (and often, highly uncertain) operational conditions. For example, studies have shown that commercial EV batteries experience significant capacity loss when operated at very high or very low SoC levels. Furthermore, battery state-of-health (SOH) may degrade when operated at ambient temperatures that deviate significantly from specified standard operating conditions. Thus, including battery efficiency and state of charge in an optimization model may result in a large computational load that may not be computationally tractable. Thus, prior approaches typically make two modeling assumptions: (i) charge and discharge efficiencies of the EV batteries are constant, and (ii) they are independent of battery SoC and ambient operating conditions (such as battery temperature). In other words, typical approaches use simplified battery efficiency models, linear battery SoC dynamics, and constant battery charge and discharge limits in optimization for scalability reasons. Battery SOH and revenue earning potential often have competing objectives and as such are typically optimized separately, which increases the difficulty of optimization. These typical approaches may lead to sub-optimal V2X decision-making, misestimated EV storage flexibility, inaccurate battery SOH calculation, and reduced battery performance over time.

FIG. 11 depicts a stochastic optimization approach and method 1100 according to an embodiment of the present invention may use a non-linear battery efficiency model to more accurately make V2X decisions and SOH calculations under dynamic uncertainty in battery operational conditions and determine adaptive battery charge/discharge strategies to maximize V2X revenue and battery SOH within a unified optimization framework. The operational conditions may include, but are not limited to, state of charge, temperature and power limits.

The optimization approach according to an embodiment of the present invention concurrently solves for one or more variables, and the variables may be functions of each other. A piecewise-linear battery efficiency model may be used to characterize discrete efficiency regimes over different ranges of values of relevant battery states, such as SoC, charge and discharge rates, and battery ambient temperatures (step 1102). Model parameters of the piecewise-linear model may be estimated using data. In an exemplary embodiment of the present approach, the data may be from controlled tests that measure battery efficiency at different battery state values over a limited number of charge-discharge cycles. This may be down over 3-4 cycles, but any suitable number of cycles may be used depending on the scenario.

In addition, during an uncertainty quantification step (step 1104), a variant of the Latin Hypercube Sampling method and a custom distance-based sampling performance metric, may be used to jointly quantify uncertainties in relevant battery states (e.g., temperature, SoC, etc.) over an optimization horizon. The output (step 1106) of the sampling method is a scenario tree that encodes the set of possible battery-state uncertainties considered while solving the optimization model and to identify robust solutions.

Using scenarios from the uncertainty quantification step and piecewise-linear efficiency model, a multi-period stochastic optimization problem is formulated (step 1108). Due to the piecewise-linear nature of the battery model, the optimization may be considered a mixed-integer stochastic programming problem. In order to improve the ability to solve such a problem, the approach according to an embodiment of the present disclosure uses a custom sampling-based, iterative, decomposition procedure known as, regularized stochastic dual dynamic programming (r-SDDP). R-SDDP uses: (a) a forward-pass step to solve a regularized optimization problem using a subset of battery-state scenarios to obtain an upper-bound of the objective value, and (b) a backward-pass step to decompose and solve smaller sub-problems to obtain a lower-bound of the objective. The r-SDDP procedure according to the present invention can efficiently handle mixed-integer variables and constraints in the optimization and provide high-quality approximate solutions of the true optimization. The r-SDDP procedure can be easily parallelized and be used asynchronously to solve the optimization using different compute nodes in cloud-based service, such as AWS.

A wide variety of competing objectives, including but not limited to, SOH, revenue, SoC deviation, power losses, may be considered in the objective function. The different objectives may be scaled and dynamically weighed based on the battery states (or scenarios).

An optimized V2X operation strategy may be derived from implementing the r-SDDP procedure to solve stochastic optimization, including a dispatch schedule with charge and discharge instructions for the electric vehicle. In an exemplary embodiment of the present invention, the optimized V2X operation strategy may be implemented in real-time. When implemented in real-time, battery performance is continuously monitored, and the optimization algorithm may be periodically re-executed to adapt to changing conditions and update the optimal operating parameters.

Each site, such as site 202 depicted in FIG. 2, may have multiple potential revenue streams that may vary in scale. For example, a customer may make ˜$30/month from time-of-use energy arbitrage and ˜$300/month from demand charge management. Most companies or OEMs elect not to pursue both objectives (time-of-use energy arbitrage and demand charge management) simultaneously in order to prevent a pursuit of a $30/month objective jeopardizing pursuit of a $300/month objective. An embodiment of the present invention allows a customer to confidently value stack multiple revenue streams by forecasting multiple potential future building power consumption scenarios, and optimizing for the expected value across all of the forecasted scenarios. The approach according to the present invention hedges and avoid pursuing lower value objectives even when there is a relatively low likelihood of the high value objective manifesting.

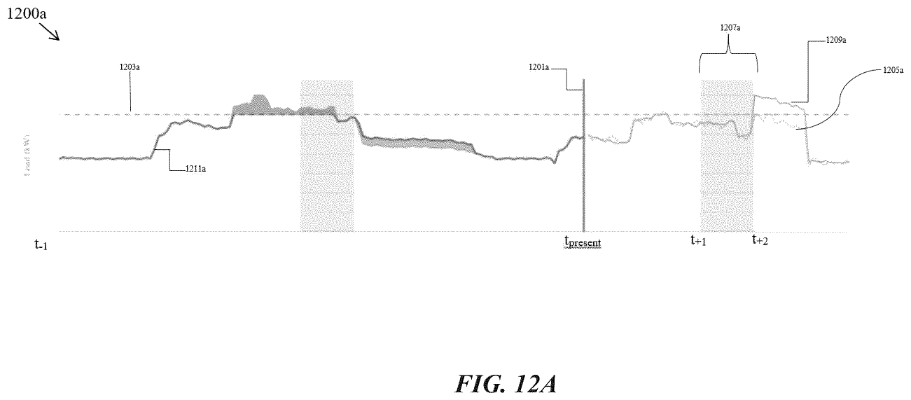

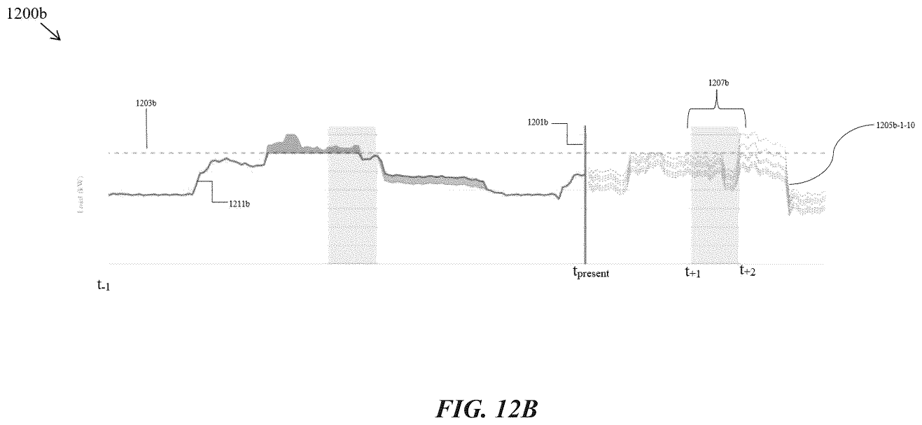

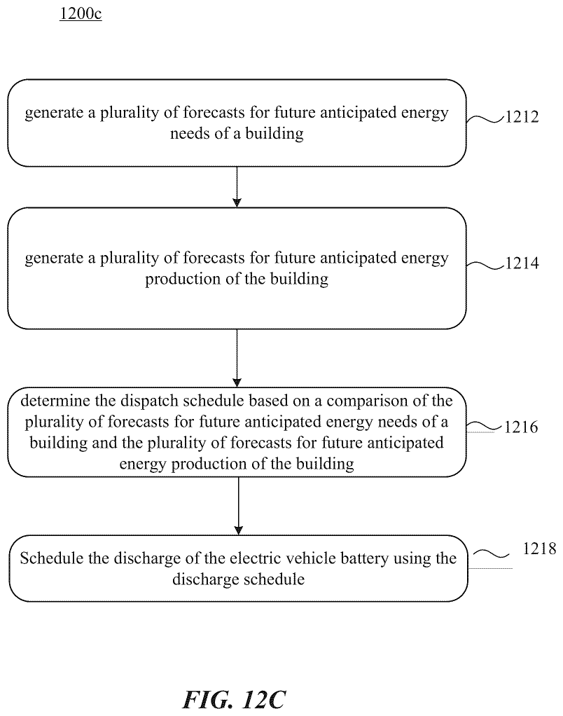

Exemplary discharge profiles 1200a and 1200b for an electric vehicle battery are depicted in FIGS. 12A & 12B. A vertical bar 1201a, 1201b indicates the present time. A maintained threshold is represented by horizontal dashed line 1203a, 1203b and the utility meter load is represented by 1211a, 1211b. The maintained threshold indicates the maximum power value that has been observed over a period of time (e.g., starting at t−1) leading up to the present time. Forecasted loads (KW) are depicted as dashed lines 1205a in FIGS. 12A and 1205b-1-10 in FIG. 12B. For example, a customer may receive $30 for discharging fully during the shaded period (time-of-use) and $300 for discharging and ensuring that the building consumption does not exceed the maintained threshold (demand charge management). In the exemplary discharge profile of FIG. 12A, load forecast 1205a indicates that at present time 1201a load is not expected to exceed the maintained threshold. Accordingly, an optimization algorithm would decide to discharge fully during the next period of time (from tₚᵣₑₛₑₙₜ to t₊₁). After discharging from present to time t₊₁, the electric vehicle would have no charge/energy remaining in the battery to defend against or respond to an unexpected demand event that occurs in the feature, such as demand response event 1207a, 1207b that occurs from time t₊₁ to time t₊₂. One simple strategy to avoid such a situation would be to scale up all forecasts as a way of hedging. However, this strategy only solves for one specific use case and does not provide a generalized solution for balancing multiple objectives. The approach according to the present invention, as illustrated in FIGS. 12B and 12C, generates multiple scenarios, attaches a probability to each, and makes decision based on the expected value across all scenarios.

In the exemplary method 1200c of FIG. 12C, multiple scenarios for energy consumption and/or energy production/generation at the site are generated (step 1212). For example, in a simplified representation of modeling performed by the approach of the present invention, optimization algorithm may be informed by 10 different scenarios of energy consumption (2505b-1-10 in FIG. 12B, where each scenario is assigned a probability. A probability or weighted probability is assigned to each of the generated scenarios (step 1214). For example, a customer receives $30 for discharging fully during the shaded period and $300 for discharging and ensuring that the building consumption does not exceed the maintained threshold. The excepted value across all generated scenarios is determined based on comparison of the probabilities and forecasted energy consumption and/or production from the scenarios (step 1216). For example, in FIG. 12B, a probability of 20% is assigned to receiving $300 for demand charge management, 2 of the 10 forecasted scenarios 1205b-1-10 exceed the maintained threshold and with a 20% chance of receiving $300 for the demand charge management results in an estimate of expected economic gain of $60. This is greater than applying a 100% chance or probability of receiving $30 from the time-of-use (i.e., just discharging the battery over the next time period) and the optimization algorithm would determine to discharge the electric vehicle for the demand charge event or otherwise generate a dispatch schedule depending on the expected values (step 1218). The present approach of probability weighted scenarios of forecast energy consumption to inform the optimization algorithm's decision of how much each charger chargers/discharges would result in a higher profit, and FIGS. 12A & 12B depicts a simplified representation of modeling that would be performed to achieve such an objective. Optimization module may only run each time an electric vehicle is plugged into (or otherwise connected to) a bi-directional charger. When optimization module is told to run, the module will grab the current forecast and state of site and generate the discharge schedule.

### Additional Capabilities of the Charger

The disclosed bi-directional charger may internally monitor temperature in the enclosure housing the power electronics components. The charger may observe temperature and upon detecting a rise or increase in temperature, the charger may de-rate the power. For example, the charger may receive a command to perform a full 15 kW charge/discharge. However, if the charger detects that the temperature is rising to excessive levels, the charger may curtail the power level back to a suitable level, such as 12.5 kW. If the temperature does not remain in a reasonable range after the power is curtailed, the charger may perform a thermal shut down. This ability to derate power before initiating a shutdown allows the disclosed charger to obtain more performance from the system before it might have to shut down, which in turn allows for supporting a higher range of operating temperatures.

The disclosed bi-directional charger may not immediately establish a charging connection when an electric vehicle is connected to the charger. When an electric vehicle is connected to the disclosed charger, the charger may require an identification code associated with the vehicle to be entered. This identification code may be manually entered into a user interface (such as described above) at the charger by a user of the electric vehicle after their electric vehicle is plugged into/connected to the charger.

The software also may provide the ability to identify the particular electric vehicle that the charger is connected to and then collect statistics and data for that particular electric vehicle, which may then be separated for long term analysis and support of battery warranty. Tracking or knowledge of battery temperature and other vehicle activities, such as those described above, may be independent of the charger (e.g., performed by the electric vehicle), in the charger, or some combination thereof (e.g., measured and communicated by the vehicle and logged and tracked by the charger). Further, through the network connection described above, the charger may communicate with the electric vehicle manufacturer to receive relevant information, such as battery temperature data regarding one or more electric vehicle batteries, to be used in long term analysis and support of battery warranty for the identified vehicle.

Alternately, the electric vehicle may have a radio-frequency identification (RFID) chip that is automatically detected by the cable gun of the charger when the charger is physically plugged into/connected to the electric vehicle. The identification code associates the particular electric vehicle with the charger and is reported to software stored on the cloud or other external server that can track metrics specific to the particular electric vehicle, such as vehicle performance and characteristics, battery state of charge, and battery temperature. The software may then analyze that data to maintain battery warranty when providing commands to the charger for charge/discharge operations with the particular electric vehicle connected to the charger.

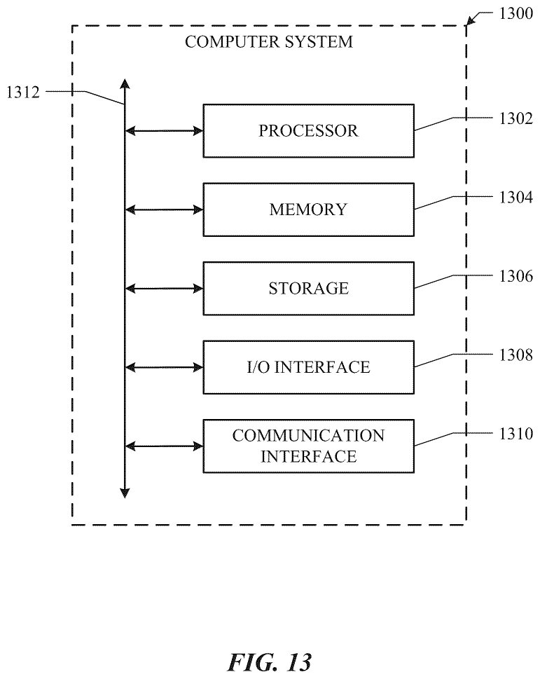

FIG. 13 illustrates an example computer system 1300 that may be utilized to perform determining a predicted touch location of a touch input, in accordance with the presently disclosed embodiments. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks.

Where appropriate, one or more computer systems 1300 may perform without substantial spatial or temporal limitation one or more steps of one or more methods described or illustrated herein. As an example, and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement. In particular embodiments, processor 1302 includes hardware for executing instructions, such as those making up a computer program. As an example, and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example, and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302.

Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example, and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere).

One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memory devices 1304, where appropriate. Although this disclosure describes and illustrates particular memory, this disclosure contemplates any suitable memory.

In particular embodiments, storage 1306 includes mass storage for data or instructions. As an example, and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it.

As an example, and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example, and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

What is claimed is:

1. An electronic device for determining a dispatch schedule for an electric vehicle battery in communication with the electronic device, the electronic device comprising:
one or more non-transitory computer-readable storage media including instructions; and
one or more processors coupled to the storage media, the one or more processors configured to execute the instructions to:
determine, using an optimization algorithm, the dispatch schedule for the electric vehicle battery; and
control a charge or discharge of the electric vehicle battery based on the dispatch schedule.

2. The electronic device of claim 1, wherein the one or more processors are further configured to execute instructions to:
determine a future state of charge of the electric vehicle battery in communication with the electronic device using a piecewise linear approximation;
determine a discharge efficiency number based on the future state of charge; and
determine anticipated energy needs of a building,
wherein the optimization algorithm uses the discharge efficiency number and the anticipated energy needs of the building to determine the dispatch schedule.

3. The electronic device of claim 2, wherein the one or more processors are further configured to execute the instructions to:
determine, using the optimization algorithm, an amount of power to charge or discharge the electric vehicle battery based on the anticipated energy needs of the building and the state of charge of the electric vehicle battery, wherein the dispatch schedule of the electric vehicle battery is further based on the amount of power to charge or discharge.

4. The electronic device of claim 2, wherein the piecewise linear approximation determines the discharge efficiency number based on at least one or more parameters relating to efficiency losses, the at least one or more parameters comprising an amount of power that is being discharged by the electric vehicle battery, a state of charge of the electric vehicle battery, or an internal temperature of the electric vehicle battery.

5. The electronic device of claim 4, wherein determining the discharge efficiency number based on at least one or more parameters comprises applying one or more weights to the one or more parameters to assign different values to each of the one or more parameters.

6. The electronic device of claim 2, wherein the piecewise linear approximation has a threshold number of inflection points.

7. The electronic device of claim 1, wherein:
controlling the charge of the electric vehicle battery comprises one or more of starting the charge of the electric vehicle battery and stopping the charge of the electric vehicle battery; and
controlling the discharge of the electric vehicle battery comprises one or more of starting the discharge of the electric vehicle battery and stopping the discharge of the electric vehicle battery.

8. The electronic device of claim 2, wherein the discharge efficiency number is further based on the discharge of the electric vehicle battery.

9. The electronic device of claim 2, wherein the one or more processors are further configured to execute instructions to:
determine, using the optimization algorithm, an amount of power to discharge based on the discharge efficiency number and the anticipated energy needs of the building, wherein the dispatch schedule is further based on the amount of power to discharge.

10. The electronic device of claim 1, wherein:
controlling the charge of the electric vehicle battery comprises one or more of setting a start time to charge the electric vehicle battery and setting a stop time to charge the electric vehicle battery; and
controlling the discharge of the electric vehicle battery comprises one or more of setting a start time to discharge the electric vehicle battery and setting a stop time to discharge the electric vehicle battery.

11. The electronic device of claim 1, wherein the optimization algorithm comprises an objective function to reduce oscillations in the discharge profile.

12. The electronic device of claim 11, wherein determine, using an optimization algorithm, the dispatch schedule for the electric vehicle battery comprises penalizing a first derivative of a variable of the objective function wherein the variable comprises a discharge of the electric vehicle battery based on a heuristic term.

13. The electronic device of claim 12, wherein the one or more processors are further configured to execute the instructions to:
receive an input from a user of the electric vehicle indicative of charge preferences or discharge preferences; and
adjusting the heuristic term based on the received input.

14. The electronic device of claim 12, wherein the heuristic term smooths a curve of a charge profile or a discharge profile associated with the dispatch schedule to reduce the oscillations.

15. The electronic device of claim 11, wherein determine, using the optimization algorithm comprises:
determining a simulation of discharging power flowing of the electric vehicle battery over a predetermined period of time; and
setting a marginal cost associated with a maximum annual discharge of the electric vehicle battery.

16. The electronic device of claim 15, wherein the optimization algorithm determines to discharge the electric vehicle battery only if an economic gain from the simulation of discharging power is greater than the marginal cost.

17. The electronic device of claim 1, wherein determining, using the optimization algorithm, comprises:
determining parameters relating to efficiency losses using a data set derived from controlled tests that measure battery efficiency at different battery state values over a limited number of charge-discharge cycles;
determining uncertainties in relevant battery states over an optimization period;
generating a plurality of scenarios that represent a set of possible battery-state uncertainties over the optimization period; and
formulating a multi-period stochastic optimization using one or more of the plurality of scenarios and the determined parameters.

18. The electronic device of claim 1, wherein the one or more processors are further configured to execute instructions to:
generate a plurality of forecasts for future anticipated energy needs of a building; and
generate a plurality of forecasts for future anticipated energy production of the building, and
wherein the optimization algorithm determines the dispatch schedule by solving for a dispatch plan that maximizes the expected value of the dispatch plan given the plurality of forecasts for future anticipated energy needs of a building and the plurality of forecasts for future anticipated energy production of the building.

19. The electronic device of claim 18, wherein each of the future anticipated energy needs of a building is associated with a respective probability of the future anticipated energy need occurring.
